(19) United States
(12) Patent Application Publication
(10) Pub. No.: US 2013/0001015 A1
(43) Pub. Date: Jan. 3, 2013

(54) DEVICE AND METHOD FOR CHANGING OUTBOARD ENGINE OIL

(76) Inventor: John S. Bettendorf, Forest Lake, MN (US)

(21) Appl. No.: 13/173,956

(22) Filed: Jun. 30, 2011

(51) Int. Cl. F16N 33/00

(52) U.S. Cl. 184/1.5

(57) ABSTRACT

A method and device for changing oil in a four cycle outboard motor.

### FIELD OF THE INVENTION

The invention relates to the field of changing motor oil. More specifically, the invention relates to changing motor oil in an outboard motor.

### BACKGROUND

Until relatively recently, outboard boat motors have generally been two cycle motors. In two cycle engines, lubrication for the internal engine parts is provided by either mixing oil with the gasoline burned in the engine or an oil injection system which injects oil into the engine along with the gasoline to provide lubrication for the pistons, cylinder walls and other internal moving engine parts. Generally, two cycle engines are noisier and produced more environmental pollutants than do four cycle engines. Accordingly, in recent years, the majority of outboard engines manufactured have been four cycle engines.

Four cycle engines are lubricated by motor oil that is placed in a sump and circulated throughout the engine by an oil pump in order to provide lubrication for pistons, cylinder walls, crank shafts and other internal engine parts. Accordingly, motor oil used in a four cycle engine requires periodic changing in order to remove accumulated dirt and other contaminants from the motor oil. To change the motor oil it is drained from the engine and replaced with fresh motor oil. Most four cycle engines include an oil sump which is readily drained out by gravity from the bottom of the engine. This drainage is complicated for outboard four cycle engines because the lower unit of the outboard motor extends downward from the engine to transmit power to the propeller.

In many four cycle outboard motors, the drain for the motor oil is located high on the engine near the top of the lower unit. This means that when the oil drain is opened and oil drains out it often runs over the lower unit and propeller and related assemblies below creating a significant mess where used motor oil adheres to and drips down the lower unit and related parts of the motor. This requires substantial cleanup after the motor oil is drained and adds to the time, expense and irritation of changing the motor oil. Accordingly, there is room for improvement in changing the motor oil in four cycle outboard motor engines.

### SUMMARY OF THE INVENTION

The present invention solves many of the above discussed problems. The present invention generally includes a specialized pipe fitting that comprises structure of both a hose barb and a pipe nipple. The specialized pipe fitting also includes an o-ring and a threaded portion to permit it to be secured to the oil drain port of a four cycle outboard motor. The invention further includes a hose couplable to the specialized fitting to provide a fluid passage for oil from the specialized fitting to an oil drain pan or other basin for collecting the used motor oil.

The present invention also includes a method of changing motor oil in a four cycle outboard engine. The method of the invention includes tilting the outboard motor to a tilted positioned in which the motor oil pools away from the drain opening. The present invention further includes removing the drain plug from the drain opening, inserting the specialized fitting into the drain opening, sealing the specialized fitting with the drain opening via an o-ring or other seal, coupling the specialized fitting to the drain hose, directing the drain hose to an oil drain pan or other basin and tilting the four cycle outboard motor to a vertical position to permit the used motor oil to drain from the engine sump via the specialized fitting and the hose into the basin.

The method may further include returning the outboard motor to a forward tilted position, removing the specialized fitting from the oil drain opening, returning the oil drain plug to the oil drain opening and replacing the removed used motor oil with fresh motor oil. The method of changing motor oil may further include refilling the oil sump by injecting motor oil under pressure upward through the drain hose and the specialized fitting into the oil sump of the four cycle outboard motor and then tilting the outboard motor to retain the fresh motor oil until the drain plug is replaced. The outboard motor may then be returned to the vertical position.

### BRIEF DESCRIPTION OF THE DRAWINGS

FIG. 1 is a photographic depiction of a fitting according to an embodiment of the invention;

FIG. 2 is a photographic depiction of a first end of the fitting including hose barbs and threads according to an embodiment of the invention;

FIG. 3 is a photographic depiction of a second end of the specialized fitting according to an embodiment of the invention;

FIG. 4 is a photographic depiction of the second end of the specialized fitting according to the an embodiment of the invention including dimensions of an example embodiment′

FIG. 5 is a photographic depiction of a specialized fitting according to an embodiment of the invention including additional dimensions;

FIG. 6 is a plan view of a specialized fitting according to an embodiment of the invention;

FIG. 7 is a photographic depiction of a specialized fitting and hose according to an embodiment of the invention;

FIG. 8 is photographic depiction of a specialized fitting and hose according to an embodiment of the invention arranged for storage;

FIG. 9 is a partially sectional view of a four cycle outboard motor in a tilted position according to an embodiment of a method of the invention; and

FIG. 10 is a partially sectional view of a four cycle outboard motor in an upright position with a fitting and hose attached according to an embodiment of the invention.

### DETAILED DESCRIPTION

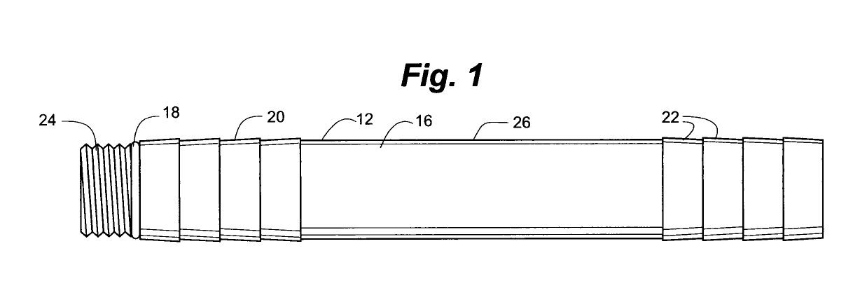

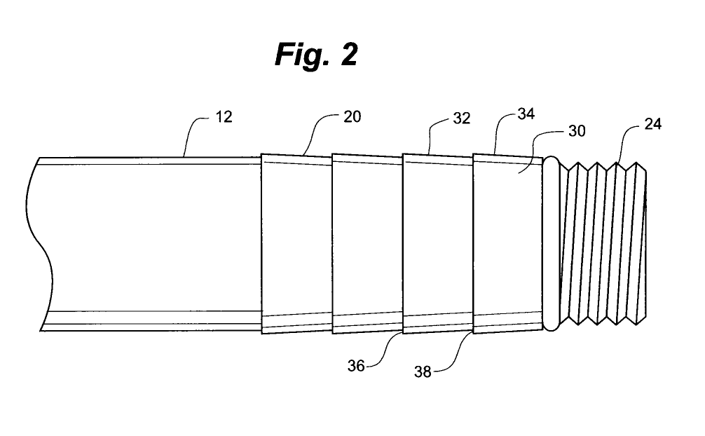

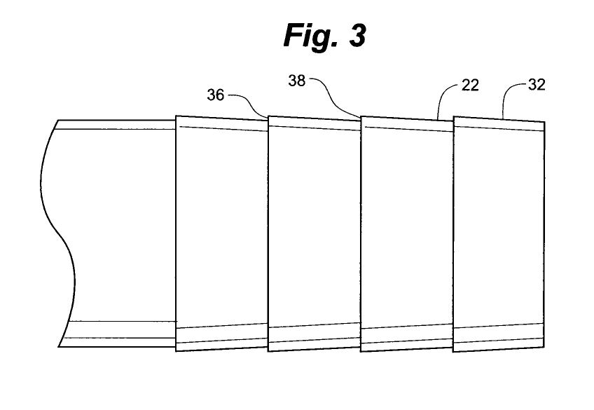

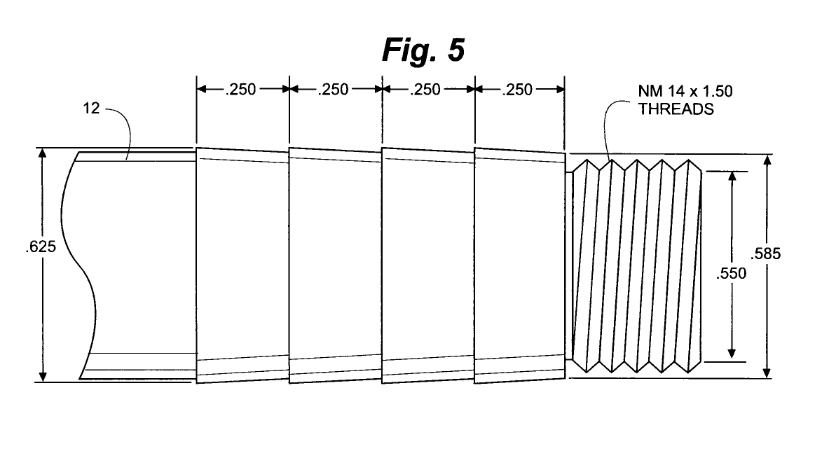

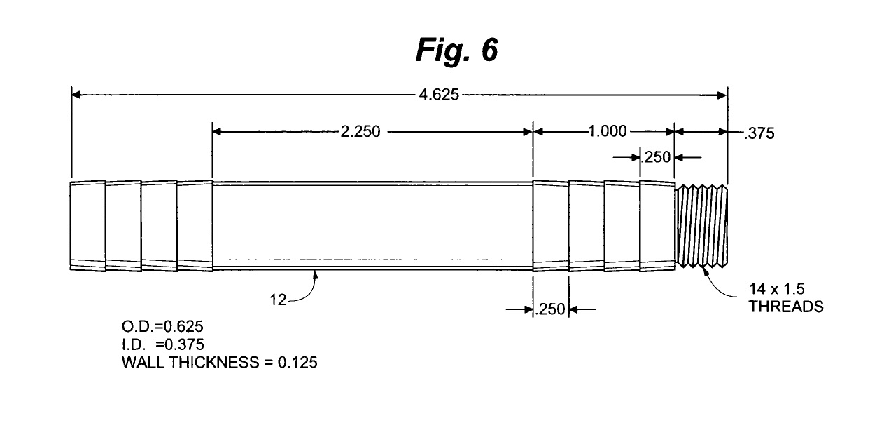

Referring to FIGS. 1-7, oil drain device 10 according to an embodiment of the invention, generally includes fitting 12 and hose 14.

Referring to FIGS. 1-5, fitting 12 generally includes tubular body 16 and o-ring 18.

Tubular body 16 is of substantially unitary construction and generally presents first hose barb portion 20, second hose barb portion 22, threaded portion 24 and central portion 26.

First hose barb portion 20 generally includes annular barbs 28. In this example embodiment, four annular barbs 28 are present though a greater or smaller number may be present.

Second hose barb portion 22 is recessed from the end of tubular body 16 behind threaded portion 24. Threaded portion 24 may for example include 14×1.5 metric threads according to one example embodiment appropriate for use with certain. This particular threading pattern should not be considered to be limiting. Threaded portion 24 also presents o-ring receiving portion 30. Second hose barb 22 generally presents annular hose barbs 32. In a depicted example embodiment, annular hose barbs 32 present four annular hose barbs 32, though a greater or lesser number may be present. Referring to particular to FIG. 1, threaded portion 24 may be separated from second hose barb portion 22 by annular ring 34.

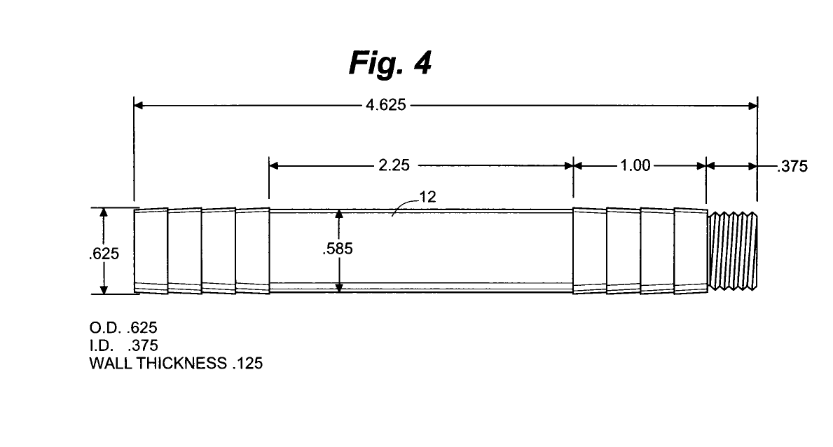

Referring to FIGS. 4-6, fitting 12 may be approximately 4.625 inches in length and have inside diameter of 0.375 inches with an outside diameter of 0.625 inches. This leads to a wall thickness of approximately 1.25 inches. First hose barb portion 20 may be approximately 1 inch in length. Second hose barb portion 22 may be approximately 1 inch in length while threaded portion 24 may be approximately 0.375 inches in length. Central portion 26 may be approximately 2.25 inches in length and have an outside diameter of approximately 0.585 inches. Central portion 26 may be knurled, ribbed or textured for gripability. Annular hose barbs 32 may have a greatest diameter 36 of approximately 0.625 inches in an example embodiment and a least diameter 38 of approximately 0.585 inches. Annular hose barbs 28 and annular hose barbs 32 may have a length of approximately 0.25 inches. According to an example embodiment, threaded portion 24 may have an outside diameter of approximately 0.550 inches.

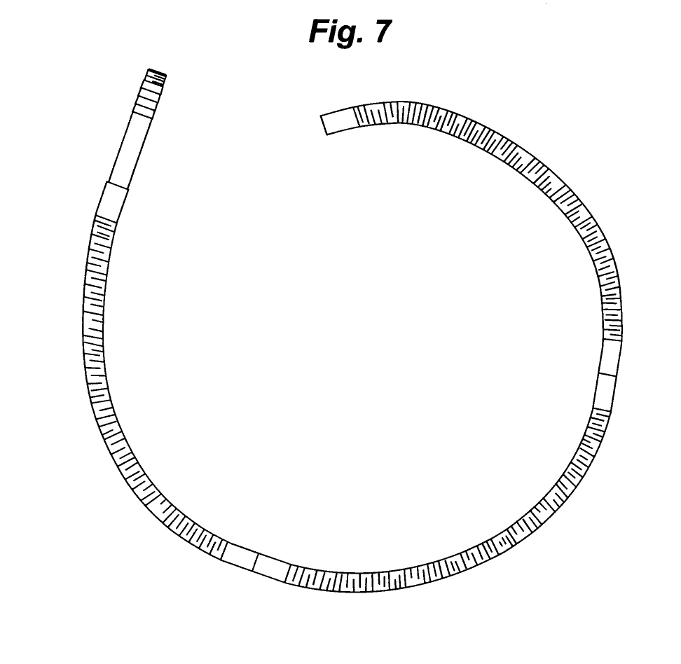

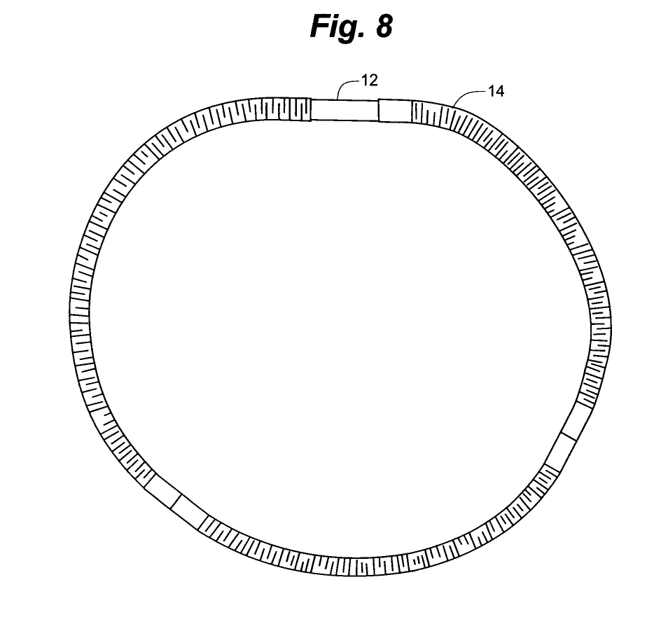

Referring to FIGS. 7-8, hose 14 is sized to fit over first hose barb portion 20 and second hose barb 22 in snuggly fitting relation. In one example embodiment, hose 14 may be approximately 37 inches in length and have an inside diameter of approximately 0.625 inches.

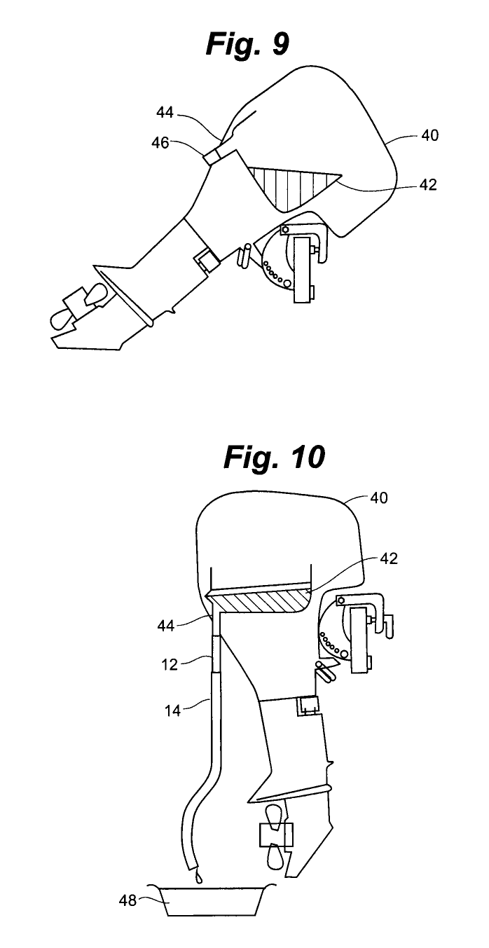

Referring to FIGS. 9 and 10, the invention also includes a method of changing motor oil in a four cycle outboard motor 40. Referring to FIG. 9, a method of the invention includes tilting outboard motor to a tilted positioned in which motor oil 42 pools away from drain opening 44. The present invention further includes removing drain plug 46 from drain opening 44, inserting threaded portion 24 of fitting 12 into drain opening 44, hand tightening fitting 12, sealing fitting 12 with the drain opening 44 via o-ring 18, coupling fitting 12 to hose 14, directing hose 14 to oil drain pan 48 or other basin and, referring to FIG. 10, tilting the four cycle outboard motor 40 to a vertical position to permit the used motor oil 42 to drain from the engine 40 sump via fitting 12 and hose 14 into oil drain pan 48.

The method may further include returning outboard motor 40 to a forward tilted position, removing fitting 12 from oil drain opening 44, returning oil drain plug 46 to the oil drain opening 44 and replacing the removed used motor oil 42 with fresh motor oil 42. The method of changing motor oil 42 may further include refilling the oil sump by injecting motor oil 42 under pressure upward through drain hose 18 and fitting 12 into the oil sump of the four cycle outboard motor 40 and then tilting the outboard motor 40 to retain the fresh motor oil 42 until fitting 12 is removed and drain plug 46 is replaced. Outboard motor 40 may then be returned to the vertical position.

Claims included in this provisional application are provided to assure adequacy of the application to establish foreign priority and for no other purpose.

1. A method of changing motor oil in a four cycle outboard motor, comprising:
placing the four cycle outboard motor in a forward tilted orientation wherein used motor oil in the motor is pooled away from a drain opening that is closed by a drain plug;
removing the drain plug from the drain opening;
securing a first end of a fitting to the drain opening in substantially sealing relation;
securing a first end of a hose to a second end of the fitting;
placing a second end of the hose proximate a container for receiving the used motor oil;
placing the four cycle outboard motor in a vertical position wherein the used motor oil drains from the four cycle outboard motor through the drain opening, the fitting and the hose into the container.

2. The method as claimed in claim 1, further comprising removing the fitting from the drain opening and replacing the drain plug in the drain opening in substantially sealing relation.

3. The method as claimed in claim 1, further comprising placing the second end of the hose over the first end of the fitting in substantially sealing relation whereby residual used motor oil is retained in the fitting and the hose.

4. The method as claimed in claim 1, further comprising injecting fresh motor oil under pressure into the four cycle outboard motor via the hose and the fitting.

5. A device for changing motor oil in a four cycle outboard motor, comprising:
a fitting having a generally tubular body having a first end and a second end and a central portion;
the first end presenting a distal threaded portion structured to threadedly engage an oil drain opening of the four cycle outboard motor when a drain plug has been removed from the oil drain opening and a first hose barb portion proximal to the threaded portion;
the second end presenting a second hose barb portion; and
a hose sized to engage the first hose barb portion and the second hose barb portion in substantially sealing relation.

6. The device as claimed in claim 5, wherein the central portion further presents at least one of knurling or texturing.

7. The device as claimed in claim 5, further comprising a sealing structure engageable to the first end of the fitting.

8. The device as claimed in claim 7, wherein the sealing structure comprises and o-ring and the first end further presents and o-ring engaging portion located proximate the threaded portion.
